(19) United States
(12) Patent Application Publication
(10) Pub. No.: US 2011/0134333 A1
(43) Pub. Date: Jun. 9, 2011

(54) Inflight entertainment system video display unit with swappable entertainment processor board

(76) Inventors: Gregory C. Petrisor, Los Angeles, CA (US); John Holyoake, Irvine, CA (US)

(21) Appl. No.: 12/928,100

(22) Filed: Dec. 3, 2010

Related U.S. Application Data
(60) Provisional application No. 61/283,378, filed on Dec. 3, 2009.

(51) Int. Cl. H04N 5/63; H04N 5/44

(52) U.S. Cl. 348/730; 348/725; 348/E05.096; 348/E05.127

(57) ABSTRACT

A video display unit (VDU) for an inflight entertainment (IFE) system, and a main circuit board and swappable entertainment processor board for use therein. The swappable entertainment processor board detachably engages with the main circuit board, allowing a main circuit board of a single design configuration to be deployed on VDUs throughout an aircraft (or across a fleet of aircraft) with entertainment processor boards of various design configurations that support different IFE feature sets. In addition to facilitating differentiated IFE services, the present invention permits rapid deployment of new technologies through redesign and swapping of entertainment processor boards. Moreover, the main circuit board may be advantageously designed to accept an industry standard entertainment processor board, which allows an entire shipset of VDUs (or a subset thereof) to be upgraded by simply swapping-in an entertainment processor board compliant with the latest version of the industry standard.

### CROSS-REFERENCE TO RELATED APPLICATION

This application claims the benefit of U.S. provisional application No. 61/283,378 entitled “INFLIGHT ENTERTAINMENT SYSTEM VIDEO DISPLAY UNIT WITH SWAPPABLE ENTERTAINMENT PROCESSOR BOARD,” filed on Dec. 3, 2009, the contents of which are incorporated herein by reference.

### BACKGROUND OF THE INVENTION

Inflight entertainment (IFE) systems have evolved significantly over the last 25 years. Prior to 1978, IFE systems consisted of audio-only systems. In 1978, Bell and Howell (Avicom Division) introduced a group viewing video system based on VHS tapes. In 1988, Airvision introduced the first in-seat video system allowing passengers to choose between several channels of broadcast video. In 1997, Swissair installed the first interactive Video on Demand (VOD) system. Currently, several IFE systems provide VOD with full digital video disc-like controls.

IFE systems require a significant amount of in-seat electronics. Legacy IFE systems house most in-seat electronics in a seat electronics box (SEB) having external cables. One external cable connects to a seatback video display, another external cable connects to a passenger control unit (PCU) in the seat arm, and one or more additional external cables are used for network connections.

More recent IFE systems eliminate SEBs and integrate the in-seat electronics formerly housed in the SEB into a single circuit board of a video display unit (VDU). This reduces the number of discrete line replaceable units (LRUs) in the IFE system, and consequently reduces IFE system operating and maintenance costs. FIG. 1 illustrates such a circuit board 100. The low complexity electronics will first be described. A power regulator 122 connects to a power source 104 and provides required power inputs to other subsystems of circuit board 100. A network interface 120 and network switch 121 provide external connectivity for the VDU by connecting to an onboard network 103. A passenger safety processor 123 is a low power embedded processor that provides an interface between an onboard passenger safety system and the following passenger safety system interfaces: flight attendant call button 112, reading light on/off button 113 and public address (PA) audio keyline 114. An audio switch 125 allows override of entertainment audio by emergency audio and provides audio output to an audio output port 111. An auxiliary audio/video input/output system 124 provides audio/video output and receives audio/video input via auxiliary audio/video input/output ports 110. A backlight controller 126 provides power for a liquid crystal display (LCD) backlight 105.

Circuit board 100 also contains high complexity electronics 101. An entertainment processor 128 provides audio/video decoding and local application execution functions. Entertainment processor 128 is connected to a universal serial bus (USB) hub 129 that provides access to USB devices, including a touch screen 107, a credit card reader 108 and auxiliary devices via auxiliary USB input/output ports 109. In addition, entertainment processor 128 is connected to an LCD panel controller 130 that provides LCD interface signals such as low voltage differential signaling (LVDS) signals directly to an LCD panel 106. Finally, entertainment processor 128 is connected to a hard drive controller 127 that connects to a hard drive 102. The hard drive may be mounted on circuit board 100 and/or a VDU frame. Additional electronics not shown in the figure may be wrapped-around entertainment processor 128.

Disadvantages arise from integrating the in-seat electronics formerly housed in the SEB into a single circuit board of a VDU as shown in FIG. 1. First, an airline may wish to provide different IFE feature sets to different classes of passengers. For example, an airline may wish to provide economy class passengers with a VDU that can simply play standard definition Moving Picture Experts Group (MPEG) audio and video, whereas the airline may wish to provide its first class passengers 1080 progressive scan (1080p) high definition video with picture-in-picture and games that require real-time three dimensional rendering. Additionally, an airline may wish to provide a VDU that has mid-tier functionality to business class passengers. These different IFE feature sets may require different entertainment processors; however, since the entertainment processor is integral to the circuit board, multiple board designs and hence multiple VDU hardware design configurations (i.e., multiple VDU LRU types) must be deployed on the aircraft, raising acquisition, operating and maintenance costs to support differentiated IFE services.

Second, an airline may wish to upgrade its IFE system after deployment to benefit from technological advances (e.g., made in terrestrial VOD systems). However, since the in-seat electronics are integral to a single circuit board, field upgrade capability is limited and wholesale replacement of VDUs is often required, once again raising system costs.

Integrating the in-seat electronics formerly housed in the SEB into a single circuit board of a VDU is also disadvantageous from the perspective of an IFE system supplier. Due to VDU space and power constraints, tight integration is required to package these electronics on a single circuit board. This can lead to increased development costs and longer development timelines, and can make it more difficult for the IFE system supplier to redesign the circuit board to adapt its VDU product offerings to evolving customer demands.

### SUMMARY OF THE INVENTION

The present invention provides a VDU for an IFE system, and a main circuit board and swappable entertainment processor board for use therein. The swappable entertainment processor board detachably engages with the main circuit board, allowing a main circuit board of a single design configuration to be deployed on VDUs throughout an aircraft (or across a fleet of aircraft) with entertainment processor boards of varied design configurations that support different IFE feature sets. In addition to facilitating differentiated IFE services, the present invention permits rapid deployment of new technologies through redesign and swapping of entertainment processor boards. Moreover, the main circuit board may be advantageously designed to accept an industry standard entertainment processor board, which allows an entire shipset of VDUs (or a subset thereof) to be upgraded by simply swapping-in an entertainment processor board compliant with the latest version of the industry standard.

In one aspect of the invention, an IFE system VDU comprises a main circuit board having a first connector and an entertainment processor board having a second connector, wherein the main circuit board and the entertainment processor board are detachably engaged via the first and second connectors whereby the main circuit board and the entertainment processor board are communicatively coupled.

In some embodiments, the main circuit board includes one or more of a power regulator, network interface, network switch, passenger safety processor, audio switch, LCD backlight controller, auxiliary audio/video input/output system or hard drive mount.

In some embodiments, the entertainment processor board includes one or more of an entertainment processor, USB hub, LCD panel controller or hard drive controller.

In some embodiments, the main circuit board and the entertainment processor board are detachably engaged using one or more mounting screws whereby the first and second connectors make electrical contact.

In some embodiments, the entertainment processor is COM Express compliant.

In another aspect of the invention, an IFE system VDU main circuit board comprises a power regulator, a network interface, a network switch, a passenger safety processor, an audio switch, an auxiliary audio/video input/output system, an LCD backlight controller and a connector that is detachably engageable with a VDU entertainment processor board.

In yet another aspect of the invention, a swappable IFE system VDU entertainment processor board comprises an entertainment processor, a USB hub, an LCD panel controller, a hard drive controller and a connector that is detachably engageable with a VDU main circuit board.

In yet another aspect of the invention, an IFE system comprises a first VDU having a first main circuit board of a first design configuration and an first entertainment processor board of a second design configuration detachably engaged with the first main circuit board, and a second VDU having a second main circuit board of the first design configuration and a second entertainment processor board of a third design configuration detachably engaged with the second main circuit board, wherein the second and third design configurations are different.

In some embodiments, the first VDU provides a first IFE feature set and the second VDU provides a second IFE feature set, and the first and second IFE feature sets are different.

These and other aspects will be better understood by reference to the following detailed description taken in conjunction with the drawings that are briefly described below. Of course, the invention is defined by the appended claims.

### BRIEF DESCRIPTION OF THE DRAWINGS

FIG. 1 shows a known circuit board for an IFE system VDU.

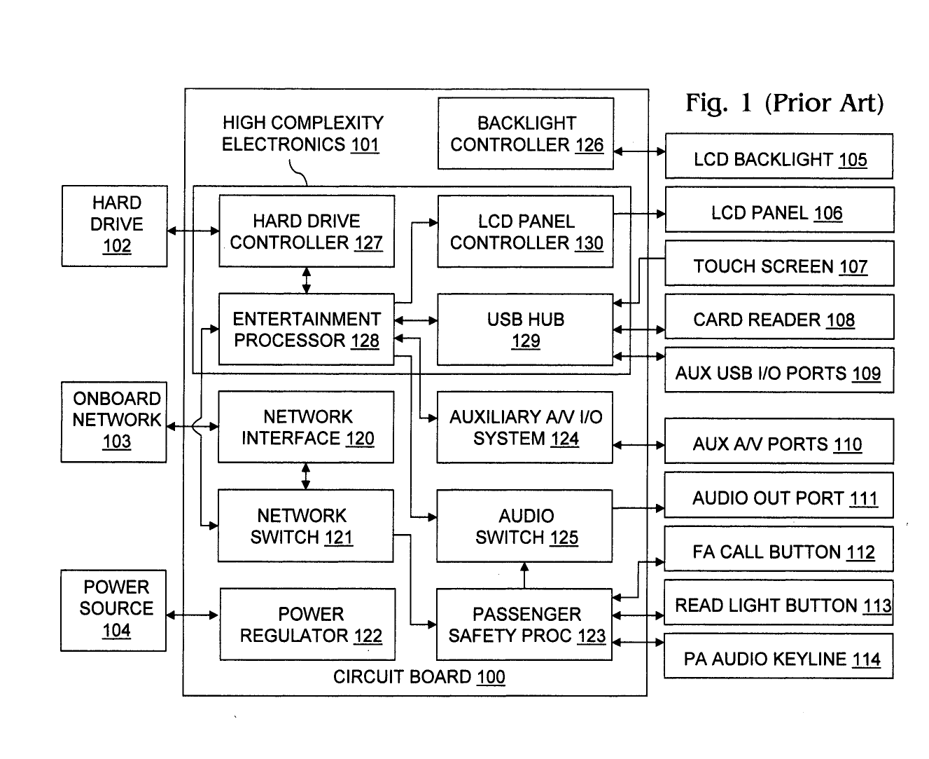

FIG. 2 shows a main circuit board for an IFE system VDU in some embodiments of the invention.

FIG. 3 shows a swappable entertainment processor board for an IFE system VDU in some embodiments of the invention.

### DETAILED DESCRIPTION OF A PREFERRED EMBODIMENT

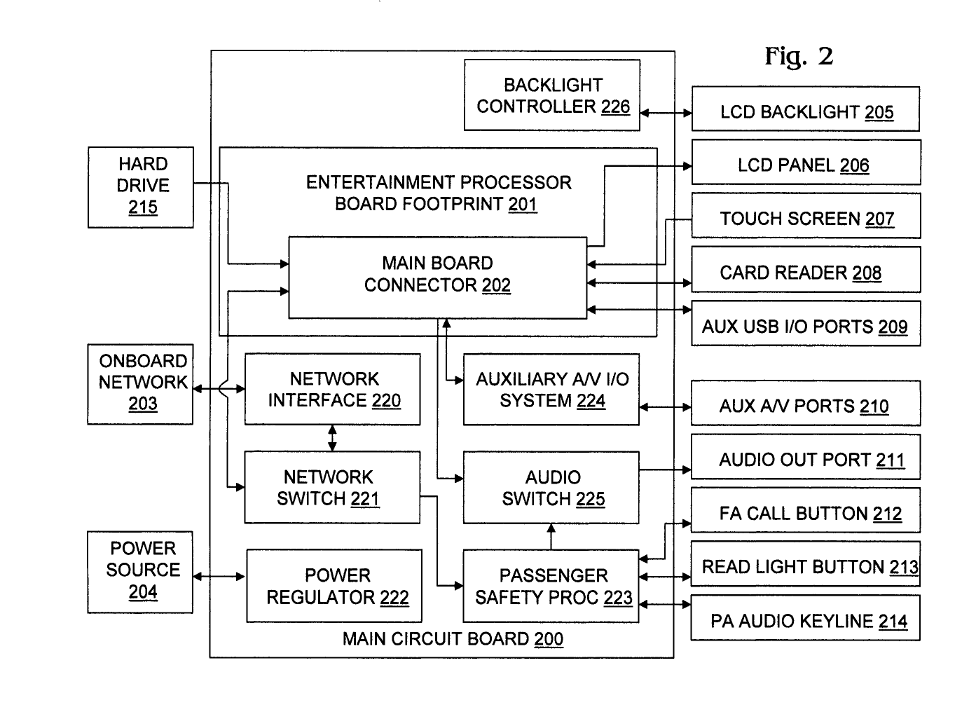

FIG. 2 shows a main circuit board 200 mounted within a VDU of an IFE system in some embodiments of the invention. Board 200 includes an entertainment processor board footprint 201 and low complexity in-seat electronics. Among the low complexity in-seat electronics are a power regulator 222, network interface 220, network switch 221, passenger safety processor 223, audio switch 225, auxiliary audio/video input/output system 224 and backlight controller 226. Power regulator 222 connects to a power source 204 external to the VDU and provides required power inputs to other subsystems of board 200. Network interface 220 and network switch 221 provide external network connectivity for the VDU by connecting to an onboard (i.e., on aircraft) network 203. Passenger safety processor 223 is a low power embedded processor that provides an interface between an onboard passenger safety system and the following passenger safety system interfaces of the VDU: flight attendant call button 212, reading light on/off button 213 and PA audio keyline 214. Audio switch 225 overrides entertainment audio in favor of emergency audio messages and provides audio output to an audio output port 211 of the VDU. Auxiliary audio/video input/output system 224 provides audio/video output and receives audio/video input via auxiliary audio/video input/output ports 210 of the VDU. Backlight controller 226 regulates power to an LCD backlight 205 of the VDU.

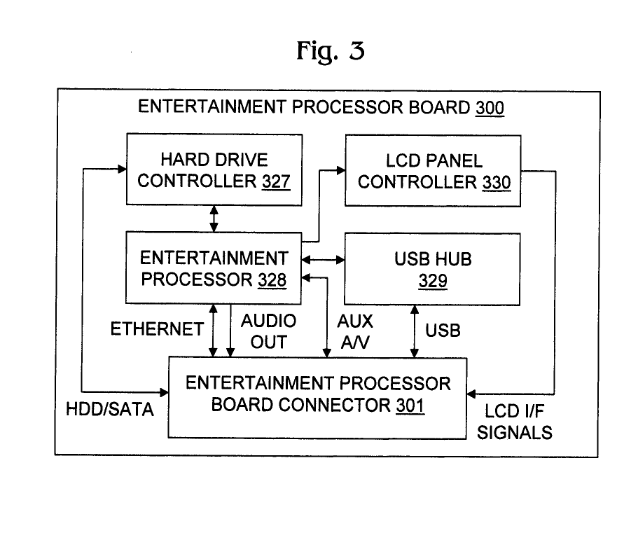

Entertainment processor board footprint 201 has a main board connector 202. Referring now to FIG. 3 in conjunction with FIG. 2, a swappable entertainment processor board 300 for an IFE system VDU detachably engages with board 200 at footprint 201 via connector 202. In some embodiments, board 300 is rigidly mounted at footprint 201 using one or more mounting screws, whereby an entertainment processor board connector 301 makes electrical contact with connector 202. In other embodiments, a different mounting mechanism, such as a latch, may be used to detachably engage connector 301 with connector 202. Regardless of the engagement mechanism, when detachably engaged with board 200 via connector 202, board 300 receives power and connectivity to onboard network 203, LCD panel 206, touch screen 207, credit card reader 208, auxiliary USB input/output ports 209, auxiliary audio/video input/output ports 210, audio output port 211 and hard drive 215.

In addition to connector 301, board 300 includes high complexity in-seat electronics that are, generally speaking, more difficult to design and debug than the in-seat electronics on board 200. An entertainment processor 328 compliant with a COM Express standard is wired to connector 301 and provides connectivity using Ethernet signaling between entertainment processor 328 and network switch 221 when board 300 is detachably engaged with board 200. Entertainment processor 328 also has an audio output wired to connector 301 for connecting with audio switch 225 on board 200 when board 300 is detachably engaged with board 200. Entertainment processor 328 further includes an auxiliary audio/video line that connects to auxiliary audio/video input/output system 224 during engagement. Entertainment processor 328 additionally has a wired connection via a USB hub 329 to a plurality of USB devices including touch screen 207, credit card reader 208 and devices connected to auxiliary USB input/output ports 209 while engaged. Entertainment processor 328 is also wired to an LCD panel controller 330, which in turn connects to LCD panel 206 and provides LCD interface signals, such as LVDS signals, during engagement. Finally, entertainment processor 328 is wired to a hard drive controller 327, which in turn connects to hard drive 215 using hard disk drive/serial advanced technology attachment (HDD/SATA) signaling during engagement. Hard drive 215 may be mounted on board 200 or otherwise mounted within the VDU.

Main circuit board 200 may be used with various entertainment processor boards (e.g., 300) that support different IFE feature sets. In that way, different levels of IFE service may be provided to different classes of passengers. Moreover, rapid deployment of new technologies may be realized through redesign and swapping of entertainment processor boards.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A video display unit (VDU) for an inflight entertainment (IFE) system, comprising:
a main circuit board having a first connector; and
a entertainment processor board having a second connector, wherein the main circuit board and the entertainment processor board are detachably engaged via the first and second connectors whereby the main circuit board and the entertainment processor board are communicatively coupled.

2. The VDU of claim 1, wherein the main circuit board includes a passenger safety processor.

3. The VDU of claim 1, wherein the main circuit board includes a network interface.

4. The VDU of claim 1, wherein the main circuit board includes a network switch.

5. The VDU of claim 1, wherein the main circuit board includes a power regulator.

6. The VDU of claim 1, wherein the main circuit board includes an audio switch.

7. The VDU of claim 1, wherein the main circuit board includes a liquid crystal display (LCD) backlight controller.

8. The VDU of claim 1, wherein the main circuit board includes an auxiliary audio/video input/output system.

9. The VDU of claim 1, wherein the main circuit board includes a hard drive mount.

10. The VDU of claim 1, wherein the entertainment processor board includes an entertainment processor.

11. The VDU of claim 1, wherein the entertainment processor board includes a universal serial bus (USB) hub.

12. The VDU of claim 1, wherein the entertainment processor board includes an LCD panel controller.

13. The VDU of claim 1, wherein the entertainment processor board includes a hard drive controller.

14. The VDU of claim 1, wherein the main circuit board and the entertainment processor board are detachably engaged using one or more mounting screws whereby the first and second connectors make electrical contact.

15. The VDU of claim 10, wherein the entertainment processor is COM Express compliant.

16. An IFE system VDU main circuit board, comprising:
a power regulator;
a network interface;
a network switch;
a passenger safety processor;
an audio switch;
an auxiliary audio/video input/output system;
an LCD backlight controller; and
a connector that is detachably engageable with a VDU entertainment processor board.

17. A swappable IFE system VDU entertainment processor board, comprising:
an entertainment processor;
a USB hub;
an LCD panel controller;
a hard drive controller; and
a connector that is detachably engageable with a VDU main circuit board.

18. An IFE system, comprising:
a first VDU having a first main circuit board of a first design configuration and an first entertainment processor board of a second design configuration detachably engaged with the first main circuit board; and
a second VDU having a second main circuit board of the first design configuration and a second entertainment processor board of a third design configuration detachably engaged with the second main circuit board, wherein the second and third design configurations are different.

19. The IFE system of claim 18, wherein the first VDU provides a first IFE feature set and the second VDU provides a second IFE feature set, wherein the first and second IFE feature sets are different.
